(19) United States
(12) Patent Application Publication
(10) Pub. No.: US 2024/0354714 A1
(43) Pub. Date: Oct. 24, 2024

(54) SYSTEM AND METHOD FOR EFFICIENT INSPECTION AND MAINTENANCE PLANNING AND ROUTING

(71) Applicant: Honeywell International Inc., Charlotte, NC (US)

(72) Inventor: Aralakuppe Ramegowda YOGESHA, Bangalore (IN)

(21) Appl. No.: 18/304,867

(22) Filed: Apr. 21, 2023

(51) Int. Cl. G06Q 10/20

(52) U.S. Cl. CPC G06Q 10/20

(57) ABSTRACT

A method is disclosed for inspection or maintenance planning at a facility, including receiving a fault message indicating a fault associated with an asset of the facility, retrieving from a plant model database location data associated with the asset, generating a digital model illustrating the location in the facility of the asset, determining a preferred route for providing service to the asset, determining a preferred sequence for providing service to the asset, generating a service plan based on the preferred route and the preferred sequence, and updating the digital model to include graphical content indicative of the service plan.

### TECHNICAL FIELD

Various embodiments of the present disclosure relate generally to systems and methods for inspection and maintenance planning, and, more particularly, to inspection and maintenance planning using a digital model to visualize a facility and/or assets thereof.

### BACKGROUND

Preventing and limiting downtime time of assets in commercial and industrial facilities is of utmost importance. Taking assets out of service, even for minutes, can be economically significant. To avoid unexpected downtime, industrial facilities make use of a variety of technologies to manage assets. For example, sensor systems may be used to monitor the health of assets (e.g., machinery, electrical system, hydraulic systems, pneumatic systems, etc.) and report breakdowns, needs for service, and the like. However, such sensor systems are typically limited in the information they provide to service workers. Conventionally, sensor systems output a text log of detected issues, placing the onus on service workers to formulate a maintenance plan for addressing the detected issues.

Because service workers are not always intimately familiar with facility layout and access points to components, the route a worker takes to address a service issue may not be optimal. Additionally, unknown conditions (e.g., machine cool downs, blocked access ways) may exist that delay access to an asset for service.

Further, modern industrial facilities rely on complex and interrelated systems that may have unforeseen effects on one another. For example, certain machinery may produce heat or vibrations that has unforeseen effects on other assets located close by. Moreover, conventional sensor systems do not have the capability to prioritize tasks or review logs to predict and prevent related service needs, cascading failures, or the like.

The present disclosure is directed to overcoming one or more of these above-referenced challenges.

### SUMMARY OF THE DISCLOSURE

In some aspects, the techniques described herein relate to a method for inspection or maintenance planning at a facility. The method includes receiving, by at least one processor, a fault message indicating a fault associated with an asset of the facility; retrieving, by at least one processor from a plant model database, location data associated with the asset; generating, by at least one processor, a digital model illustrating the location in the facility of the asset; determining, by at least one processor, a preferred route for providing service to the asset; determining, by at least one processor, a preferred sequence for providing service to the asset; generating, by at least one processor, a service plan based on the preferred route and the preferred sequence; and updating, by at least one processor, the digital model to include graphical content indicative of the service plan.

In some embodiments, the method further includes determining, by at least one processor after receiving the fault message, that the plant model database does not include location data associated with the asset; receiving, by at least one processor from a user, location data associated with the asset; and updating, by at least one processor, the plant model database to include the location data associated with the asset.

In some embodiments, the graphical content includes at least one of at least one path for accessing the asset, and a present location of a technician.

In some embodiments, the method further includes determining, by at least one processor, that a constraint affects the preferred route; and determining, by at least one processor and based on the constraint, a new preferred route for providing service to the asset.

In some embodiments, the method further includes logging, by at least one processor, fault data associated with the asset into a historical fault database;

In some embodiments, the method further includes determining, by at least one processor, at least one of a potential failure mode of the asset associated with the fault message, a root cause of the fault associated with the fault message, and one or more probable failure effects; and generating, by at least one processor, a maintenance decision based on at least one of the potential failure modes, the root cause, and the one or more probable failure effects.

In some embodiments, the method further includes generating, by at least one processor, a recommendation based on at least one of the potential failure modes, the root cause, and the one or more probable failure effects. The recommendation is at least one of a recommendation for a future maintenance operation and a recommendation for a future facility design.

Other embodiments of the present disclosure are directed to a computer system for inspection or maintenance planning at a facility. The computer system includes at least one memory having processor-readable instructions stored therein and at least one processor configured to access the memory and execute the processor-readable instructions, which when executed by the processor configure the processor to perform a plurality of functions. The plurality of functions include receiving a fault message indicating a fault associated with an asset of the facility, retrieving, from a plant model database, location data associated with the asset, generating a digital model illustrating the location in the facility of the asset, determining a preferred route for providing service to the asset, determining a preferred sequence for providing service to the asset, generating a service plan based on the preferred route and the preferred sequence, and updating the digital model to include graphical content indicative of the service plan.

In some embodiments, the plurality of functions further includes determining, after receiving the fault message, that the plant model database does not include location data associated with the asset; receiving location data associated with the asset; and updating the plant model database to include the location data associated with the asset.

In some embodiments, the graphical content includes at least one of at least one path for accessing the asset, and a present location of a technician.

In some embodiments, the plurality of functions further includes determining that a constraint affects the preferred route, and determining, based on the constraint, a new preferred route for providing service to the asset.

In some embodiments, the plurality of functions further includes logging fault data associated with the asset into a historical fault database.

In some embodiments, the plurality of functions further includes determining at least one of a potential failure mode of the asset associated with the fault message, a root cause of the fault associated with the fault message, and one or more probable failure effects; and generating a maintenance decision based on at least one of the potential failure modes, the root cause, and the one or more probable failure effects.

In some embodiments, the plurality of functions further includes generating a recommendation based on at least one of the potential failure modes, the root cause, and the one or more probable failure effects. The recommendation is at least one of a recommendation for a future maintenance operation and a recommendation for a future facility design.

Other embodiments of the present disclosure are directed to a non-transitory computer-readable medium containing instructions for inspection or maintenance planning at a facility. The non-transitory computer-readable medium stores instructions that, when executed by at least one processor, configure the at least one processor to perform receiving a fault message indicating a fault associated with an asset of the facility; retrieving, from a plant model database, location data associated with the asset; generating a digital model illustrating the location in the facility of the asset; determining a preferred route for providing service to the asset; determining a preferred sequence for providing service to the asset; generating a service plan based on the preferred route and the preferred sequence; and updating the digital model to include graphical content indicative of the service plan.

In some embodiments, the instructions further configure the at least one processor to perform determining, after receiving the fault message, that the plant model database does not include location data associated with the asset; receiving, from a user, location data associated with the asset; and updating the plant model database to include the location data associated with the asset.

In some embodiments, the graphical content includes at least one of at least one path for accessing the asset and a present location of a technician.

In some embodiments, the instructions further configure the at least one processor to perform determining that a constraint affects the preferred route, and determining, based on the constraint, a new preferred route for providing service to the asset.

In some embodiments, the instructions further configure the at least one processor to perform logging fault data associated with the asset into a historical fault database;

In some embodiments, the instructions further configure the at least one processor to perform determining at least one of a potential failure mode of the asset associated with the fault message, a root cause of the fault associated with the fault message, and one or more probable failure effects; and generating a maintenance decision based on at least one of the potential failure modes, the root cause, and the one or more probable failure effects.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for planning inspection and maintenance of assets in a facility, according to one or more embodiments.

FIG. 2 depicts a plan view of a facility and assets thereof, according to one or more embodiments.

FIG. 3 depicts an architecture for inspection and maintenance planning and routing, according to one or more embodiments.

FIG. 4 depicts a flowchart of a method for planning inspection and maintenance of assets in a facility, according to one or more embodiments.

FIG. 5 depicts a flowchart of a method for planning inspection and maintenance of assets in a facility, according to one or more embodiments.

FIG. 6 depicts a digital model of a facility and assets thereof, according one or more embodiments.

FIG. 7 depicts an implementation of a computer system that may execute techniques presented herein, according to one or more embodiments.

### DETAILED DESCRIPTION OF EMBODIMENTS

Various embodiments of the present disclosure relate generally to systems and methods for inspection or maintenance planning using a digital model to visualize a facility. The systems and methods described herein may improve inspection and maintenance operations, relative to conventional systems, by automatically generating an itinerary and displaying optimal routes associated with performance of operations to a technician. More particularly, optimal routes for performing operations may be displayed on a virtual, digital model incorporating a three-dimensional (hereinafter “3D”) model of the facility, thereby expediting maintenance and/or service operations. Furthermore, embodiments of the present disclosure may automatically determine relationships between various faults (e.g., cascading failures) to optimize maintenance and/or service operations.

Thus, the systems and methods of the present disclosure provide technician(s) with information and recommendations not provided in conventional systems, which simply provide a log of faults that need to be addressed with no route guidance or analysis of relational data between multiple faults.

Furthermore, embodiments of the present disclosure may automatically generate recommendations for maintenance operations and/or recommendations for future facility design by assessing modes of component failure, occurrences of cascading failures, and the like.

Subject matter will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended reflect or indicate that the embodiment(s) is/are “example” embodiment(s). Subject matter be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). Furthermore, the method presented in the drawings and the specification is not to be construed as limiting the order in which the individual steps may be performed. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” or “in some embodiments” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or semi-supervised training may be employed. For example, supervised learning may include providing training data and labels corresponding to the training data, e.g., as ground truth. Any suitable type of training may be used, e.g., stochastic, gradient boosted, random seeded, recursive, epoch or batch-based, etc.

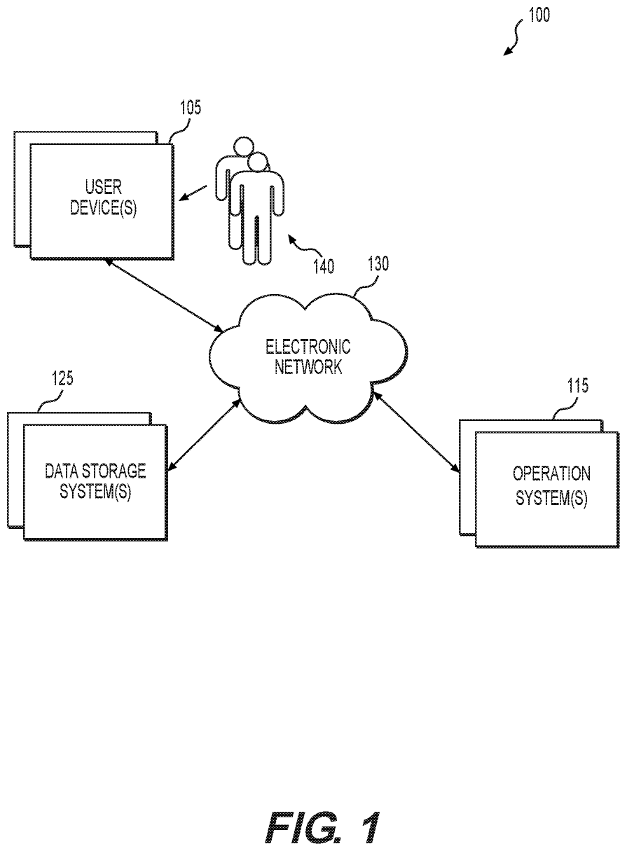

Referring now to the accompanying drawings, FIG. 1 depicts an exemplary environment 100 that may be utilized with techniques presented herein. One or more user devices 105 used by one or more users 140 (e.g., technicians or other employees of an industrial facility), one or more operation system(s) 115, and one or more data storage systems 125 may communicate across an electronic network 130.

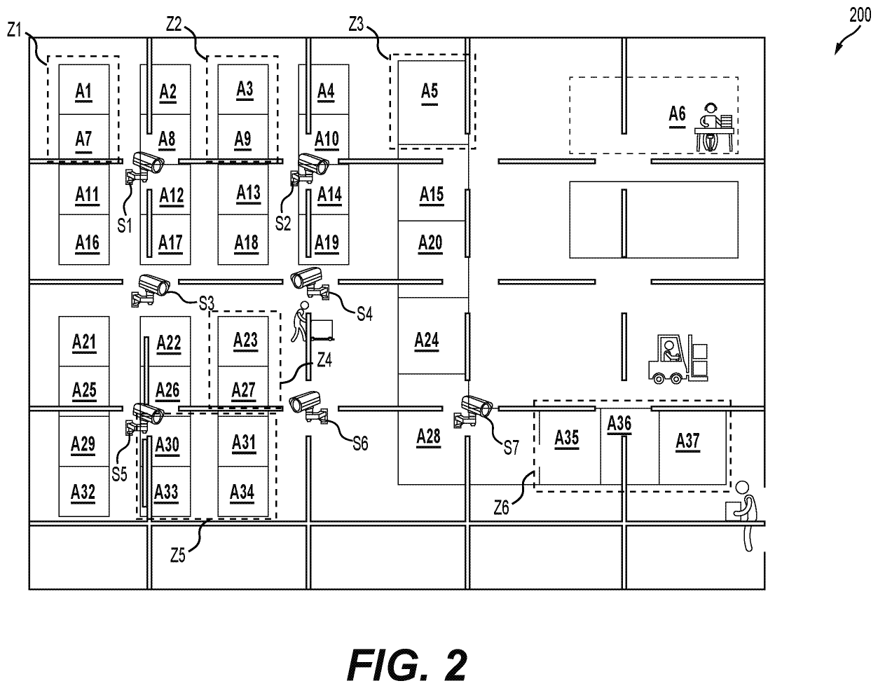

In some embodiments, components of environment 100 are associated with a common entity, e.g., facility 200 of FIG. 2. In some embodiments, one or more of the components of environment 100 is associated with a different entity than another. The systems and devices of environment 100 may communicate in any arrangement. As will be discussed herein, systems and/or devices of environment 100 may communicate in order to share and display data to user 140, to generate recommendations and/or optimal courses of action, and/or to train and/or use machine-learning model(s) to diagnose and make design recommendations relating to asset faults.

User device 105 may be configured to enable user 140 to access and/or interact with other systems in environment 100. For example, user device 105 may be a computer system such as, for example, a desktop computer, a mobile device, a tablet, a facility terminal, etc. In some embodiments, user device 105 may include one or more electronic application(s), e.g., a program, plugin, browser extension, etc., installed on a memory of user device 105. In some embodiments, the electronic application(s) may be associated with one or more of the other components in environment 100. For example, the electronic application(s) may include one or more of system control software, system monitoring software, software development tools, etc.

Particularly, user device 105 may be configured to display a graphical user interface providing user 140 with useful information, such as preferred routes for servicing assets, preferred sequences for performing service operations, real-time updates to facility conditions, and other information as described in detail herein.

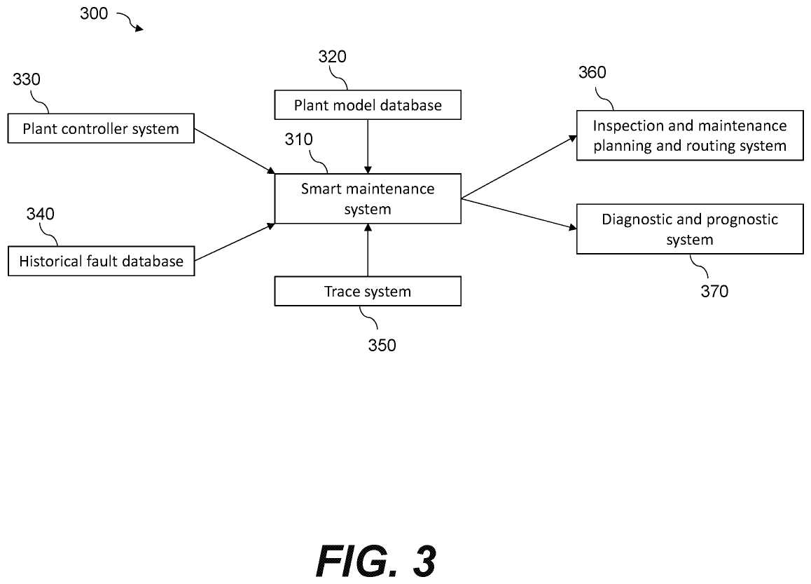

Data storage system 125 includes any physical and virtual devices configured to store data, such as data related to facility layout (e.g. facility 200 of FIG. 2), data related to assets within the facility (e.g. asserts A1-A37 of FIG. 2), data related to current and historical faults associated with assets of the facility, data related to preferences and/or capabilities of user 140, and the like. In some embodiments, data storage system 125 may include a server system, an electronic data system, computer-readable memory such as a hard drive, flash drive, disk, etc. In some embodiments, data storage system 125 may be cloud-based. In some embodiments, data storage system 125 includes and/or interacts with an application programming interface for exchanging data to other systems, e.g., one or more of the other components of the environment. Data storage system 125 may include and/or act as a repository or source for asset data, historical fault data, and the like as described herein. Data storage system 125 may include, for example, plant model database 320 and historical fault database 340, as will be described herein in connection with FIG. 3.

In various embodiments, electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, operation system(s) 115 may receive and or generate data associated with assets and operations of a facility (e.g. facility 200 of FIG. 2), and utilize that data to generate preferred routes and/or sequences for performing tasks, and/or to generate recommendations for performing tasks or designing facilities. Further, operation system(s) 115 may train and use one or more machine-learning models to diagnosis and make recommendations based upon fault data associated with assets of a facility. Operation system(s) 115 may include various control systems and subsystems within a facility, such as smart maintenance system 310, plant controller system 330, trace system 350, inspection and maintenance planning and routing system 360, and diagnostic and prognostic system 370, as will be described herein in connection with FIG. 3.

Operation association system 115 may include a machine-learning model and/or instructions associated with the machine-learning model, e.g., instructions for generating a machine-learning model, training the machine-learning model, using the machine-learning model, etc. The training data may include historical fault data associated with assets of the facility (e.g., facility 200 of FIG. 2). In some embodiments, the training data may include historical preference data associated with user 140 (e.g., data associated with user's preference for navigating, sequencing and/or performing tasks).

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn correlations/associations between fault data (present and historical) and particular zones of a facility, such that the trained machine-learning model is configured to determine an association in response to the input fault data based on the learned correlations/associations.

Although depicted as separate components in FIG. 1, it should be understood that a component or portion of a component in environment 100 may, in some embodiments, be integrated with or incorporated into one or more other components. For example, a portion of a display may be integrated into user device 105 or the like. In another example, the operation association system 115 may be integrated into data storage system 125. In some embodiments, operations or aspects of one or more of the components discussed above may be distributed amongst one or more other components. Any suitable arrangement and/or integration of the various systems and devices of environment 100 may be used.

Referring now to FIG. 2, a plan view of a facility 200 is illustrated. Facility 200 houses various assets A1-A37 such as machinery, electrical systems, hydraulics systems, pneumatic systems, and the like. Assets A1-A37 may be stationary, such as manufacturing equipment, conveyors, power generating equipment, etc.; or mobile, such as trucks, forklifts, carts, cranes, etc. Certain areas of facility 200 may form zones Z1-Z6, which experience relatively increased ambient conditions, and/or represent particular safety concerns, based on the location of particular assets. For example, a high voltage zone Z1 may be present around electrical assets A1, A7. Likewise, a vibration zone Z2 may be present around machinery assets A3, A9 that produce significant vibrations. Likewise, an explosive zone Z3 may be present around asset A5 that is susceptible to explosion. Likewise, a high temperature zone Z4 may be present around assets A23, A27 that emit exceptional amounts of heat. Likewise, a high pressure zone Z5 may be present around assets A30, A31, A33, A34 that generate or store pressurized fluids. Likewise, a mechanical stress zone Z6 may be present around assets A35, A36, A37 that experience exceptional mechanical stress due to the ambient environment.

Other examples of zones that are not illustrated but may nevertheless be present in facility 200 include a condensation zone where condensation and/or moisture may create a corrosive environment, and an electrical interference zone present around assets emitting high levels of electromagnetic interference. Though not illustrated, various zones Z1-Z6 may overlap and include some or all of the same assets A1-A37. Furthermore, zones may not necessarily be defined by geographical proximity. In some embodiments, two or more assets A1-A37 may be in the same zone if those assets share the same power supply and/or power bus. In some embodiments, two or more assets A1-A37 may be in the same zone if those assets operate on the same hydraulic or pneumatic circuit. In some embodiments, two or more assets A1-A37 may be in the same zone if those assets communicate using the same communication channels (e.g., Wi-Fi, Ethernet, 4G, etc.).

With continued reference to FIG. 2, each of assets A1-A37 may be monitored by one or more sensors S1-S7. Sensors S1-S7 may be configured to detect operating conditions of respective assets A1-A37, detect component failures of respective assets A1-A37, detect wear and/or degradation of respective assets A1-A37, and the like. Sensors S1-S7 may include any type and/or combination of devices that measure and/or detect operating conditions of assets A1-A37, including but not limited to temperature sensors, pressure sensors, optical sensors, encoders, resolvers, limit switches, EMF sensors, ammeters, voltmeters, strain gauges, moisture sensors, and combinations thereof. Sensors S1-S7 may be connected to one or more control systems (e.g., plant controller system 330, see FIG. 3) that receive data (e.g., in the form of one or more electrical signals, from sensors S1-S7. Though seen sensor S1-S7 are illustrated, it is to be understood that facility 200 may include more or less sensors, and in some embodiments, may have multiple sensors associated with each asset A1-A37.

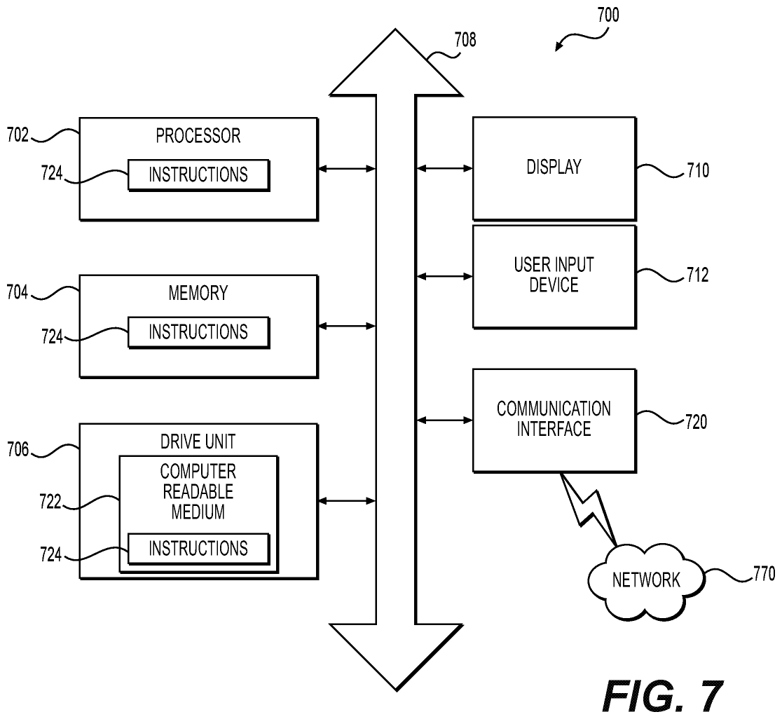

Referring now to FIG. 3, architecture 300 for efficient inspection and maintenance planning and routing is illustrated in accordance with an embodiment of the present disclosure. Architecture 300 includes smart maintenance system 310 configured to receive input(s) from plant model database 320, plant controller system 330, historical fault database 340, and trace system 350. Smart maintenance system 310 is configured to generate output(s) to inspection and maintenance planning and routing system 360 and/or diagnostic and prognostic system 370. Each of smart maintenance system 310, plant model database 320, plant controller system 330, historical fault database 340, trace system 350, maintenance planning and routing system 360, and diagnostic and prognostic system 370 may include a controller configured to execute that various functions described herein, such as controller 700 of FIG. 7.

Smart maintenance system 310 may be configured to execute various methods (e.g. methods 400, 500) disclosed herein in order to plan maintenance tasks, generate optimal/preferred routes for technicians executing maintenance tasks, generate optimal/preferred sequences of maintenance tasks, and the like using.

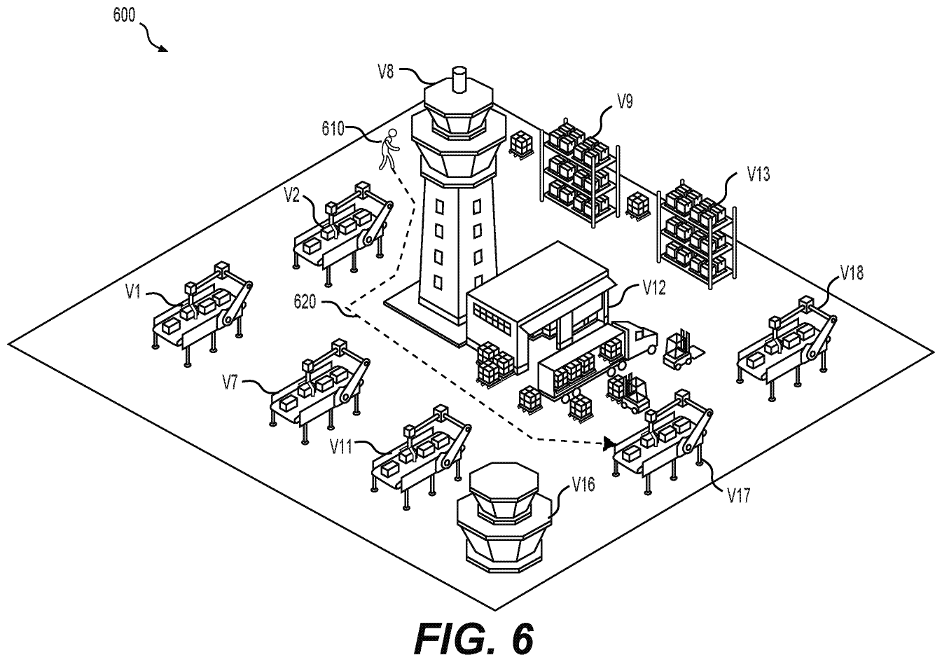

Plant model database 320 includes modelling information relating to facility 200. In particular, plant model database 320 includes three dimensional (“3D”) model data of facility 200, including the internal layout, building plan, electrical equipment, electrical cables, communication cables, HVAC ducting, plumbing lines, and associated components. Plant model database 320 further includes 3D model data and layout data of assets A1-A37 and sensors S1-S7. The 3D model data contained in plant model database 320 may be used to generate a 3D model of facility 200, as shown in FIG. 6. Plant model database 320 may be part of or connected to a database (e.g. data storage system 125 of FIG. 1) in which the model data is stored.

Plant controller system 330 includes the main control system(s) of assets A1-A37 of facility 200. Plant controller system 330 is in communication with sensors S1-S7 to monitor real-time status (i.e. fault or no-fault status) of assets A1-A37. Plant controller system 330 receives signals from sensors S1-S7 indicative of the status of assets A1-A37, and transmits the status (particular any fault statutes) to smart maintenance system 310.

Trace system 350 includes asset data related to assets A1-A37 and sensors S1-S7 of facility 200. Trace system 350 may include, for example, data relating to maintenance schedule, service history, replacement parts, and the like of assets A1-A37.

Maintenance planning and routing system 360 is configured to assess fault information received from sensors S1-S7 and their geographical/zonal location. Based on this assessment, maintenance planning and routing system 360 is configured to generate recommended maintenance actions for assets A1-A37, generate maintenance scheduling with efficient and optimal routes for performing maintenance actions, generate optimal sequences for performing maintenance actions, and perform related function to minimize maintenance time.

Diagnostic and prognostic system 370 is configured to generate recommendations for future service operations and/or recommendations for facility design improvements based on the fault data received by plant controller system 330 and the historical fault data in historical fault database 340. In particular, diagnostic and prognostic system 370 is configured to assess faults recorded by plant controller 330 by analyzing factors such as geographical location of assets A1-A37 relative to one another and to zones Z1-Z6, existence of other of faults in facility 200, and historical information known or learned from historical fault database 340. Based on these and other relevant operational factors, diagnostic and prognostic system 370 may determine a failure mode, a root cause of a fault, and/or one or more probable failure effects associated with a fault. Diagnostic and prognostic system 370 may include one or more artificial intelligence and/or machine learning models that are trained on historical fault data in historical fault database 340 in order to make recommendations.

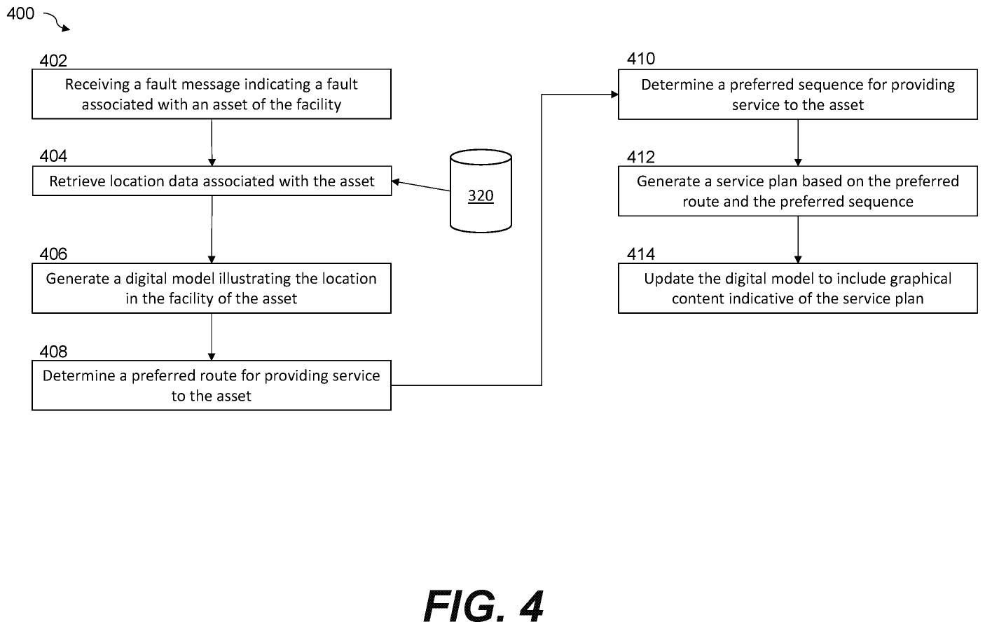

Referring now to FIG. 4, illustrated is a flow diagram of method 400 for inspection or maintenance planning at a facility (e.g., facility 200 of FIG. 2), in accordance with an embodiment of the present disclosure. For purposes of explanation, method 400 will be explained in the context of a fault being detected in asset A17 of the plurality of assets A1-A37, though method 400 is equally applicable to faults in any of assets A1-A37 or combination of assets A1-A37. Each of steps 402-414 of method 400 may be performed automatically by at least one processor, such as included in controller 700, associated with smart maintenance system 310, plant controller system 330, maintenance planning and routing system 360, and/or diagnostic and prognostic system 370.

With continued reference to FIG. 4, method 400 includes, at step 402, receiving at least one fault message each indicating a fault associated with asset A17 of the facility 200. In some embodiments, the fault may be detected automatically by one or more sensors S1-S7 associated with asset A17 of the facility 200, which are in communication with the plant controller system 330. In other embodiments, the fault may be detected manually by a worker at the facility, and the fault message may be manually input into a device (e.g., user device 105 of FIG. 1) connected to plant controller system 330. The plant controller system 330 may then generate the fault message based on the input of the worker. The fault message is received by a device (e.g., user device 105 of FIG. 1). The fault message corresponds to a service operation which is ultimate assigned to a technician to perform.

With continued reference to FIG. 4, method 400 includes, at step 404, retrieving, from plant model database 320, location data associated with the component of the fault message. The location data includes the geographical location of the asset A17 within the facility 200. The location data may also include a floor that the technician must be on to access the faulty component of asset A17, the direction or position from which the technician must approach asset A17 to access the component, etc. Plant model database 320 may be queried for location data based on a unique identification number associated with the faulty component of asset A17.

With continued reference to FIG. 4, method 400 includes, at step 406, generating a digital model illustrating the location in facility 200 of asset A17 associated with the fault messages received at step 402. The digital model may include a 3D model (e.g. model 600 of FIG. 6) of facility 200, including a floorplan, structure (e.g., walls, doors), walkways, and assets A1-A37 of facility 200. The 3D model may highlight or otherwise emphasize the component of the fault message for easy identification of the component by the technician.

With continued reference to FIG. 4, method 400 includes, at step 408, determining a preferred route for providing service to asset A17 associated the fault message(s). Step 408 may be performed, for example, by maintenance planning and routing system 360. The preferred route may correspond to an optimal route that minimizes technician travel time to the faulty component, minimizes technician travel distance to the component, and/or is the safest route to the component. The safest route may avoid, for example, potential hazards such as spills, other open maintenance operations, and other situations that are a potential delay or safety risk to the technician. In some embodiments, maintenance planning and routing system 360 may implement a machine learning algorithm to tailor the preferred route to the particular technician to which the service operation is assigned, based on historical data associated with that technician. For example, for technicians that have a learned history of being relatively risk-averse, the preferred route may prioritize safety over travel speed and/or distance.

With continued reference to FIG. 4, method 400 includes, at step 410, determining a preferred sequence for providing service to the components of assets A17 and any other components and/or assets A1-AA37 associated with the fault message(s). Step 410 may be performed, for example, by maintenance planning and routing system 360. The preferred sequence may be an optimal sequence that minimizes technician travel time and/or travel distance between the asset A17 associated with the fault identified at step 402 and other assets A1-A37 for which the technician is assigned a service operation. In some embodiments, the preferred sequence may organize the service operations in a manner that directs the technician to take a path with a minimal amount of backtracking and/or meandering. In some embodiments, the preferred sequence may further group service operations based on type, such as electrical, hydraulic, mechanical, etc., if doing so improves the efficiency of the technician. Maintenance planning and routing system 360 may implement a machine learning algorithm to tailor the preferred sequence to the particular technician to which the service operations are assigned based on historical data associated with that technician. For example, the preferred sequence may group service operations of a particular type for a particular time of day based on learned preferences of the technician.

An additional factor that may be taken into account when determining the preferred sequence at step 410 may include, for example, asset location relative to other faults. For example, the preferred sequence may group service operations in a manner that multiple assets to be serviced within the same zone Z1-Z6 and/or within physical proximity to one another are organized to minimize overall technician travel time. Another factor that may be taken into account when determining the preferred sequence at step 410 may include, for example, estimated repair time of the fault. For example, faults may be organized so that those requiring less repair time are completed first, thereby returning assets to service in the most efficient manner. Furthermore, faults may be organized to maximize the number of faults that can be resolved within a technician's work day.

With continued reference to FIG. 4, method 400 includes, at step 412, generating a service plan based on the preferred route (determined at step 408) and the preferred sequence (determined at step 410). Step 412 may be performed, for example, by maintenance planning and routing system 360. The service plan may thus include the preferred route(s) arranged in the preferred sequence. The service plan may be stored as data transmittable to user device 105 so that the service plan can be incorporated into the model (e.g., model 600 of FIG. 6)

With continued reference to FIG. 4, method 400 includes, at step 414, updating the digital model to include graphical content indicative of the service plan. The graphical content may include, for example, an illustration of at least one route (i.e. the preferred route determined at step 408) for accessing the component. The graphical content may further include, for example, a present location of the technician within facility 200. The graphical content may be implemented using any suitable software and/or hardware. For example, the graphical content may be displayed as a transparent skin overlaying the 3D model.

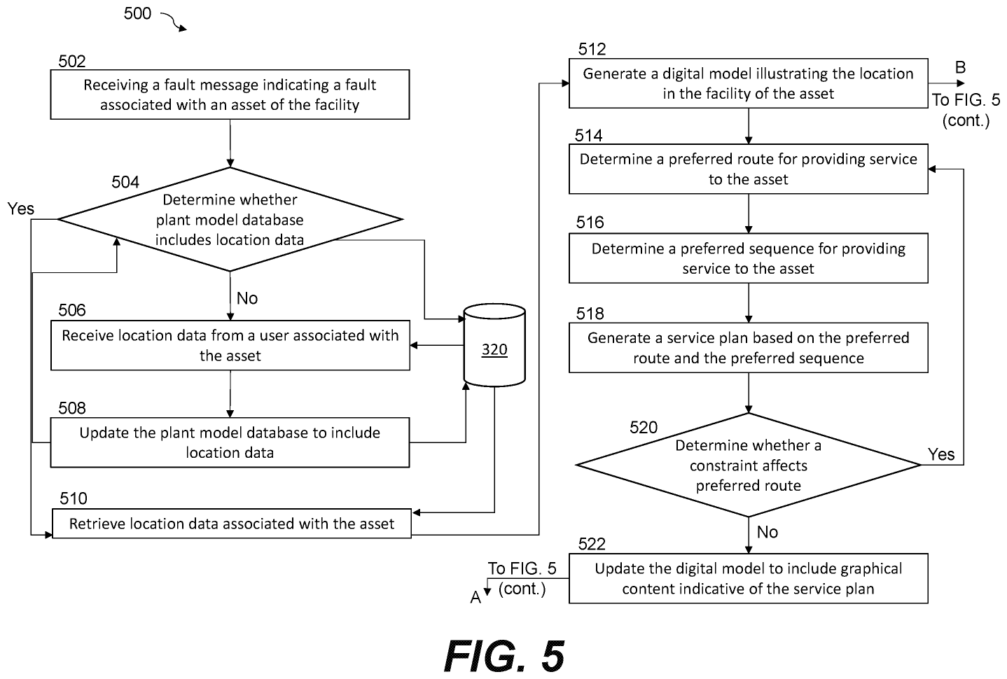

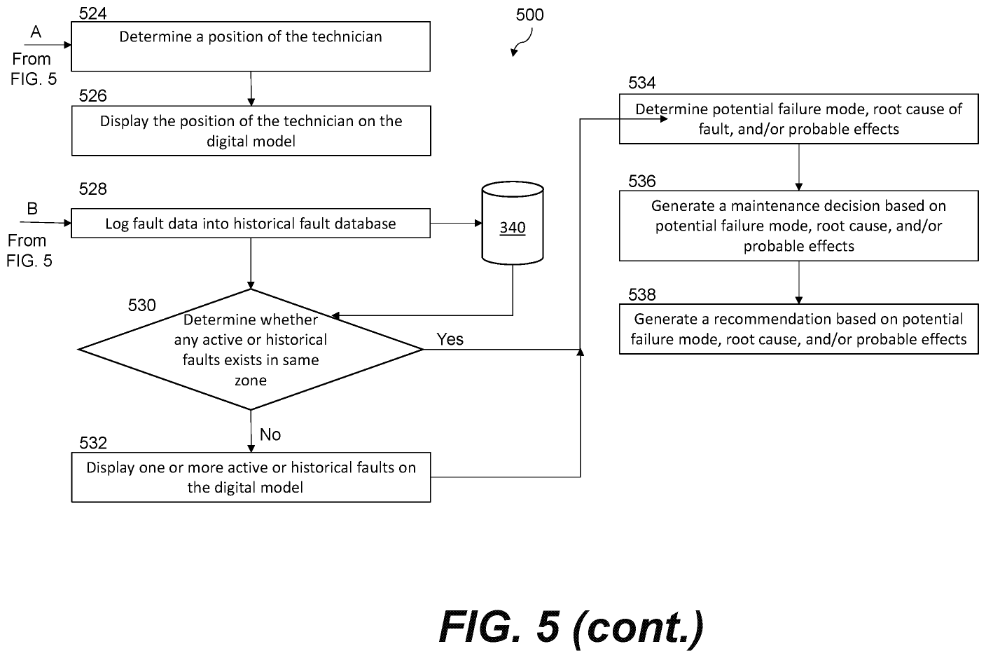

Referring now to FIG. 5, illustrated is a flow diagram of method 500 for inspection or maintenance planning at facility 200, in accordance with an embodiment of the present disclosure. For purposes of explanation, method 500 will be explained in the context of a fault being detected in asset A17 of the plurality of assets A1-A37, though method 400 is equally applicable to faults in any of assets A1-A37 or combination of assets A1-A37. Each of steps 502-538 of method 500 may be performed automatically by at least one processor, such as included in controller 700, associated with smart maintenance system 310, plant controller system 330, maintenance planning and routing system 360, and/or diagnostic and prognostic system 370.

With continued reference to FIG. 5, method 500 includes, at step 502, receiving at least one fault message each indicating a fault associated with asset A17 of facility 200. Step 502 of method 500 may be substantially identical to step 402 of method 400, as described herein.

With continued reference to FIG. 5, method 500 includes, at step 504, determining whether plant model database 320 includes location data associated with asset A17 associated with fault request. If it is determined that plant model database 320 includes location data associated with asset A17, method 500 proceeds to step 510, described below. If it is determined that plant model database 320 does not include location data associated with asset in question, method 500 proceeds to steps 506 and 508.

At step 506, method 500 includes receiving location data from a user associated with the asset A17 associated with the fault. The user may be, for example, the technician or another facility employee. The user may enter the location data into a handheld device, terminal, etc. such as input device 105 of FIG. 1 connected to plant model database 320. At step 508, method 500 includes updating plant model database 320 to include the location data received at step 506. After plant model database has been updated to reflect the received location data, method 500 returns to step 504. In this iteration of step 504, it should be determined that plant model database 320 includes location data associated with the asset in question, as plant model database 320 was updated with that location data at step 508.

With continued reference to FIG. 5, method 500 includes, at step 510, retrieving, from plant model database 330, location data of the asset A17 associated with each of the fault messages. Method 500 further includes, at step 512, generating a digital model (e.g. model 600 of FIG. 6) illustrating the location in the facility of the assets A1-A37 associated with each of the fault messages. Method 500 includes, at step 514, determining a preferred route for providing service to the asset. Method 500 includes, at step 516, determining a preferred sequence for providing service to asset A17 and any other assets A1-A37 associated with fault messages. Method 500 includes, at step 518, generating a service plan based on the preferred route and the preferred sequence determined at step 514 and 516, respectively. Steps 510, 512, 514, 516, and 518 of method 500 may be substantially identical to steps 404, 406, 408, 410, and 412, respectively, of method 400, as described herein.

With continued reference to FIG. 5, method 500 may further include, at step 520, determining whether a constraint affects the preferred route and/or the preferred sequence. The constraint may be, for example, that asset A17 to be serviced has not adequately cooled to safely perform the service operation. Such may be the case if asset A17 is a motor or other component that must cool down prior to being touched by a technician to perform service. Step 520 may be performed at a time subsequent to the determination of the preferred route at step 514 and/or subsequent to determination of the preferred sequence at step 516, such as after the technician has begun executing the service plan generated at step 518. Determination that a constraint exists indicates that the service plan generated at step 518 may no longer represent the optimal plan for addressing all faults, as alternative routes and/or sequences may be faster, safer, and/or cover less distance.

Another example of a constraint determined at step 520 may include unavailability of a spare part(s) needed to address a fault. For example, the lead time for a spare part(s) may not allow service to be completed in the preferred sequence.

If a constraint is identified, method 500 returns to step 514 and re-determines the preferred route based on the constraint. If the constraint results in a change in the originally-determined preferred route no longer being optimal, a new preferred route is determined. Similarly, the preferred sequence is re-determined at step 516 based on the constraint, and, if the originally-determined sequence is no longer optimal, a new preferred sequence is determined.

Step 520 may be performed continuously or intermittently (e.g., at predetermined time intervals) throughout performance of the service operations so that the technician(s) is regularly provided with adjustments to the service plan to maximize efficiency.

Referring again to step 520 of method 500, if no constraint is identified, method 500 may proceed to step 522, which includes updating the digital model to include graphical content indicative of the service plan. Step 522 of method 500 may be substantially identical to step 414 of method 400. The graphical content is inclusive of any changes to the preferred route and/or preferred sequence (i.e., the new preferred route and/or new preferred sequence) determined from performing previous iterations of step 520.

With continued reference to FIG. 5, method 500 may further include, at step 524, determining a position of the technician(s). In some embodiments, the position of the technician(s) may be determined by one or more sensors S1-S7 in communication with plant controller system 330. In some embodiments, the position of the technician(s) may be transmitted by a device (e.g., a GPS-enabled device, such as user device 105) carried or worn by the technician(s).

With continued reference to FIG. 5, method 500 may further include, at step 526, displaying the position of the technician(s) with respect to assets A1-A37 on the digital model. The technician(s) may thus utilize the digital model as a guide to reach assets A1-A37 for service.

With continued reference to FIG. 5, method 500 may further includes steps for performing prognosis and/or diagnosis of the fault identified at step 502. Prognosis and/or diagnosis method step 528-538 may be performed, for example, by diagnostic and prognostic system 370. Prognosis and/or diagnosis method step 528-538 may be performed at substantially any time after the fault(s) is identified at step 502. In some embodiments, prognosis and/or diagnosis method step 528-538 may follow step 512, and may be performed concurrently with steps 514-526, as shown in FIG. 5. In other embodiments, prognosis and/or diagnosis method step 528-538 may be performed after step 526, or as a substantially independent method detached from the remaining steps of method 500.

At step 528, method 500 includes logging fault data associated with asset A17 of the fault message into historical fault database 340. Fault data may include, for example, date/time of the fault, geographical location of asset A17, any zones Z1-Z6 with which asset A17 is associated, and the like. The logged fault data may be used during subsequent iterations of method 500 to improve prognostic and diagnostic capabilities of method 500, as will be discussed herein. Further, the logged fault data may be used by smart maintenance system 310 and/or diagnostic and prognostic system 370 to improve a machine learning model used for generating recommendations with respect to future faults and/or facility design improvements, as will be discussed herein

With continued reference to FIG. 5, method 500 includes, at step 530, determining whether any active or historical faults have been documented in the same zone(s) Z1-Z6 as asset A17 associated with the fault message received at step 502. Data relating to the zone(s) in which asset A17 is located may be stored in historical fault database 340. In particular, a record of each historical fault may include the zone(s) Z1-Z6 associated with the fault (presuming zone data was provided when the historical fault was logged).

If no exact matches are found at step 530—i.e., if historical fault database 340 does not include specific data relating to the zone in which historical fault(s) occurred-method 500 may include, at step 532, displaying one or more active or historical faults on the digital model. That is, the digital model (e.g. model 600 of FIG. 6) is updated to overlay historical faults (obtained from historical fault database 340) on the assets A1-A37 of the model with which those historical faults are associated. Such overlaid historical faults may include, for example, all nearby faults for which information is available. The technician(s) can then manually identify relationships between the present fault and historical faults—e.g., any active/historical faults that are in the same zone(s) Z1-Z6 as the present fault. In particular, the historical faults may be displayed as a transparent skin overlaying the 3D model of the facility. The technician(s) can navigate through the digital model, identifying and assessing various zones Z1-Z6 of interest. The historical faults may also be displayed as a timeline, allowing the technician(s) to identify and assess patterns of fault occurrences, fault propagation, and maintenance/service history. Method 500 then proceeds to step 534, described below. Data regarding the identified fault may be added to historical fault database 340 so that the identified fault is presented to user via the digital model in subsequent iterations of method 500.

Referring again to step 530 of method 500, if one or more matches to the present fault are identified in historical fault database 340, method 500 proceeds directly to step 534.

At step 534, method 500 includes determining at least one of a possible failure mode of asset A17, a root cause of the fault, and one or more probable failure effects based on the historical fault data. If one or more exact matches to the present fault (received at step 502) was identified in historical fault database 340 at step 530, the possible failure mode, root cause, and/or one or more probable failure effects may be retrieved from data stored in historical fault database 340. If an exact match to the present fault was not identified in historical fault database 340 at step 530, diagnostic and prognostic system 370 may predict the possible failure mode, root cause, and/or one or more probable failure effects utilizing a machine learning algorithm based on data associated with active and/or historical faults identified as relevant by the technician(s) at step 532. For example, if the fault is a wiring failure associated with asset A17, knowledge of any zones Z1-Z6 in which asset A17 is located may be instructive in determining a failure mode and/or probable cause of the fault that may otherwise be difficult to determine. For example, wiring failure occurring in vibration zone Z2 and/or high temperature zone Z4 may be due to the relatively high levels of vibration and/or heat, respectively, in those zones Z2, Z4 (e.g., heat may penetrate the protective layer of the wiring and cause damage). However, it may not be readily apparent solely from human observation and/or data collected by sensors S1-S7 that heat and/or vibration are the cause of a fault. However, if multiple instances of the same or similar faults (in this example, wire failure) have historically occurred in zones Z2, Z4, diagnostic and prognostic system 370 may determine that such repeated instances of faults are causally related to zones Z2, Z4.

With continued reference to FIG. 5, method 500 may further include, at step 536, generating a maintenance decision based on the possible failure mode, root cause, and/or one or more probable failure effects determined at step 534. The maintenance decision may include, for example, replacing or recalibrating a particular component of asset A17; verifying an electrical, hydraulic, pneumatic connection; adding vibration isolation to asset A17; adding additional cooling devices and or shielding around asset A17; and/or other remedial actions to rectify the detected fault(s). In the previously described example of wire failures located in the vibration and/or temperature zones Z2, Z4, the maintenance decision may include replacing damaged wires, and improving shielding of the new wires to mitigate heat effects in high temperature zone Z4. Further, the maintenance decision may include leaving additional slack in the new wires to mitigate vibratory effects in vibration zone Z2.

With continued reference to FIG. 5, method 500 may further include, at step 538, generating a recommendation based on at least one of the potential failure modes, the root cause, and the one or more probable failure effects. The recommendation may be at least one of a recommendation for a future maintenance operation and a recommendation for a future design improvement to facility 200. The recommendation for a future design improvement may be, for example, arranging assets A1-37 in a manner that mitigates commonly encountered faults. For example, future installation of wiring near vibration zone Z2 and high temperature zone Z4 may be shielded to prolong the working life of the wire in stressful ambient conditions. Alternatively, installing wires in vibration zone Z2 and high temperature zone Z4 may be avoided when possible.

FIG. 6 depicts an exemplary digital model 600 of a facility, such as may be displayed on user device 105 during performance of method 400 and/or method 500. Model 600 may be a 3D model displayed on a device having a display screen, such as user device 105 of FIG. 1, held by a technician during performance of one or more maintenance or service operations. Model 600 may be generated from data retrieved from plant model database 320 and data generated by smart maintenance system 310 and/or inspection and maintenance planning and routing system 360. Model 600 particularly includes virtual representations of structure (e.g. walls) of facility; virtual representations of walkways of facility; virtual representation of assets V1, V2, V7, V8, V9, V11, V12, V13, V16, V17, V18, which respectively correspond to assets A1, A2, A7, A8, A9, A11, A12, A13, A16, A17, A18 of facility 200 (note that model 600 may include virtual representations corresponding to all of assets A1-A37 of facility 200, but the accompanying drawing shows only a portion thereof for clarity). In some embodiments, model 600 may further include virtual representations of zone Z1, Z6 of facility 200.

With continued reference to FIG. 6, model 600 may further include a virtual representation of a technician 610 (e.g., the technician holding user device 105 on which model 600 is displayed) indicating the real-world relative position of the technician with respect to assets of facility. Model 600 may further include a virtual representation of a route 620 corresponding to the preferred route generated at step 408 of method 400 or step 514 of method 500. Route 620, as shown in FIG. 6, illustrates the preferred route for technician to follow reach asset A17 (corresponding to virtual representation V17 in model 600) from the technician's current position.

As described herein, model 600 may be continually updated as the technician moves about facility 200, as the technician completes service/maintenance operations, as asset data is retrieved from plant model database 320, as constraints are detected in real-time (see step 520 of method 500), and the like.

FIG. 7 depicts an implementation of a controller 700 that may execute techniques presented herein, according to one or more embodiments.

The controller 700 may include a set of instructions that can be executed to cause the controller 700 to perform any one or more of the methods or computer based functions disclosed herein. The controller 700 may operate as a standalone device or may be connected, e.g., using a network, to other computer systems or peripheral devices.

In a networked deployment, the controller 700 may operate in the capacity of a server or as a client in a server-client user network environment, or as a peer computer system in a peer-to-peer (or distributed) network environment. The controller 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a headset, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 700 can be implemented using electronic devices that provide voice, video, or data communication. Further, while the controller 700 is illustrated as a single system, the term “system” shall also be taken to include any collection of systems or sub-systems that individually or jointly execute a set, or multiple sets, of instructions to perform one or more computer functions.

As illustrated in FIG. 7, the controller 700 may include at least one processor 702, e.g., a central processing unit (CPU), a graphics processing unit (GPU), or both. The processor 702 may be a component in a variety of systems. For example, the processor 702 may be part of a standard computer. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The controller 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 includes a cache or random-access memory for the processor 702. In alternative implementations, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 700 may further include a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 may act as an interface for the user to see the functioning of the processor 702, or specifically as an interface with the software stored in the memory 704 or in the drive unit 706.

Additionally or alternatively, the controller 700 may include an input device 712 configured to allow a user to interact with any of the components of controller 700. The input device 712 may be a number pad, a keyboard, or a cursor control device, such as a mouse, or a joystick, touch screen display, remote control, headset, or any other device operative to interact with the controller 700.

The controller 700 may also or alternatively include drive unit 706 implemented as a disk or optical drive. The drive unit 706 may include a computer-readable medium 722 in which one or more sets of instructions 724, e.g. software, can be embedded. Further, the instructions 724 may embody one or more of the methods or logic as described herein. The instructions 724 may reside completely or partially within the memory 704 and/or within the processor 702 during execution by the controller 700. The memory 704 and the processor 702 also may include computer-readable media as discussed above.

In some systems, a computer-readable medium 722 includes instructions 724 or receives and executes instructions 724 responsive to a propagated signal so that a device connected to a network 770 can communicate voice, video, audio, images, or any other data over the network 770. Further, the instructions 724 may be transmitted or received over the network 770 via a communication port or interface 720, and/or using a bus 708. The communication port or interface 720 may be a part of the processor 702 or may be a separate component. The communication port or interface 720 may be created in software or may be a physical connection in hardware. The communication port or interface 720 may be configured to connect with a network 770, external media, the display 710, or any other components in controller 700, or combinations thereof. The connection with the network 770 may be a physical connection, such as a wired Ethernet connection or may be established wirelessly as discussed below. Likewise, the additional connections with other components of the controller 700 may be physical connections or may be established wirelessly. The network 770 may alternatively be directly connected to a bus 708.

While the computer-readable medium 722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 722 may be non-transitory, and may be tangible.

The computer-readable medium 722 can include a solid-state memory such as a memory card or other package that houses one or more non-volatile read-only memories. The computer-readable medium 722 can be a random-access memory or other volatile re-writable memory. Additionally or alternatively, the computer-readable medium 722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 700 may be connected to a network 770. The network 770 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 770 may include wide area networks (WAN), such as the Internet, local area networks (LAN), campus area networks, metropolitan area networks, a direct connection such as through a Universal Serial Bus (USB) port, or any other networks that may allow for data communication. The network 770 may be configured to couple one computing device to another computing device to enable communication of data between the devices. The network 770 may generally be enabled to employ any form of machine-readable media for communicating information from one device to another. The network 770 may include communication methods by which information may travel between computing devices. The network 770 may be divided into sub-networks. The sub-networks may allow access to all of the other components connected thereto or the sub-networks may restrict access between the components. The network 770 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for inspection or maintenance planning at a facility, the method comprising:
receiving, by at least one processor, a fault message indicating a fault associated with an asset of the facility;
retrieving, by at least one processor from a plant model database, location data associated with the asset;
generating, by at least one processor, a digital model illustrating the location in the facility of the asset;
determining, by at least one processor, a preferred route for providing service to the asset;
determining, by at least one processor, a preferred sequence for providing service to the asset;
generating, by at least one processor, a service plan based on the preferred route and the preferred sequence; and
updating, by at least one processor, the digital model to include graphical content indicative of the service plan.

2. The method of claim 1, further comprising:
determining, by at least one processor after receiving the fault message, that the plant model database does not include location data associated with the asset;
receiving, by at least one processor from a user, location data associated with the asset; and
updating, by at least one processor, the plant model database to include the location data associated with the asset.

3. The method of claim 1, wherein the graphical content includes at least one of:
at least one path for accessing the asset; and
a present location of a technician.

4. The method of claim 1, further comprising:
determining, by at least one processor, that a constraint affects the preferred route; and
determining, by at least one processor and based on the constraint, a new preferred route for providing service to the asset.

5. The method of claim 1, further comprising:
logging, by at least one processor, fault data associated with the asset into a historical fault database.

6. The method of claim 1, further comprising:
determining, by at least one processor, at least one of:
a potential failure mode of the asset associated with the fault message;
a root cause of the fault associated with the fault message; and
one or more probable failure effects; and
generating, by at least one processor, a maintenance decision based on at least one of the potential failure modes, the root cause, and the one or more probable failure effects.

7. The method of claim 6, further comprising:
generating, by at least one processor, a recommendation based on at least one of the potential failure modes, the root cause, and the one or more probable failure effects,
wherein the recommendation is at least one of:
a recommendation for a future maintenance operation; and
a recommendation for a future facility design.

8. A computer system for inspection or maintenance planning at a facility, the computer system comprising:
at least one memory having processor-readable instructions stored therein; and
at least one processor configured to access the memory and execute the processor-readable instructions, which when executed by the processor configure the processor to perform a plurality of functions, including functions for:
receiving a fault message indicating a fault associated with an asset of the facility;
retrieving, from a plant model database, location data associated with the asset;
generating a digital model illustrating the location in the facility of the asset;
determining a preferred route for providing service to the asset;
determining a preferred sequence for providing service to the asset;
generating a service plan based on the preferred route and the preferred sequence; and
updating the digital model to include graphical content indicative of the service plan.

9. The system of claim 8, wherein the plurality of functions further comprises:
determining, after receiving the fault message, that the plant model database does not include location data associated with the asset;
receiving location data associated with the asset; and
updating the plant model database to include the location data associated with the asset.

10. The system of claim 8, wherein the graphical content includes at least one of:
at least one path for accessing the asset; and
a present location of a technician.

11. The system of claim 8, wherein the plurality of functions further comprises:
determining that a constraint affects the preferred route; and
determining, based on the constraint, a new preferred route for providing service to the asset.

12. The system of claim 8, wherein the plurality of functions further comprises:
logging fault data associated with the asset into a historical fault database.

13. The system of claim 8, wherein the plurality of functions further comprises:
determining at least one of:
a potential failure mode of the asset associated with the fault message;
a root cause of the fault associated with the fault message; and
one or more probable failure effects; and
generating a maintenance decision based on at least one of the potential failure modes, the root cause, and the one or more probable failure effects.

14. The system of claim 13, wherein the plurality of functions further comprises:
generating a recommendation based on at least one of the potential failure modes, the root cause, and the one or more probable failure effects,
wherein the recommendation is at least one of:
a recommendation for a future maintenance operation; and
a recommendation for a future facility design.

15. A non-transitory computer-readable medium containing instructions for inspection or maintenance planning at a facility, the non-transitory computer-readable medium storing instructions that, when executed by at least one processor, configure the at least one processor to perform:
receiving a fault message indicating a fault associated with an asset of the facility;
retrieving, from a plant model database, location data associated with the asset;
generating a digital model illustrating the location in the facility of the asset;
determining a preferred route for providing service to the asset;
determining a preferred sequence for providing service to the asset;
generating a service plan based on the preferred route and the preferred sequence; and
updating the digital model to include graphical content indicative of the service plan.

16. The non-transitory computer-readable medium of claim 15, wherein the instructions further configure the at least one processor to perform:
determining, after receiving the fault message, that the plant model database does not include location data associated with the asset;
receiving, from a user, location data associated with the asset; and
updating the plant model database to include the location data associated with the asset.

17. The non-transitory computer-readable medium of claim 15, wherein the graphical content includes at least one of:
at least one path for accessing the asset; and
a present location of a technician.

18. The non-transitory computer-readable medium of claim 15, wherein the instructions further configure the at least one processor to perform:
determining that a constraint affects the preferred route; and
determining, based on the constraint, a new preferred route for providing service to the asset.

19. The non-transitory computer-readable medium of claim 15, wherein the instructions further configure the at least one processor to perform
logging fault data associated with the asset into a historical fault database.

20. The non-transitory computer-readable medium of claim 15, wherein the instructions further configure the at least one processor to perform:
determining at least one of:
a potential failure mode of the asset associated with the fault message;
a root cause of the fault associated with the fault message; and
one or more probable failure effects; and
generating a maintenance decision based on at least one of the potential failure modes, the root cause, and the one or more probable failure effects.
